(19) United States
(12) Patent Application Publication
(10) Pub. No.: US 2010/0252646 A1
(43) Pub. Date: Oct. 7, 2010

(54) SYSTEM AND METHOD FOR MAGNETIZING AGRICULTURAL SPRAY

(75) Inventor: John McCammack, Orlando, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: MCCAMMACK & LENHARDT, LLC, Orlando, FL (US)

(21) Appl. No.: 12/753,446

(22) Filed: Apr. 2, 2010

Related U.S. Application Data
(60) Provisional application No. 61/165,961, filed on Apr. 2, 2009.

(51) Int. Cl. B05B 9/03

(52) U.S. Cl. 239/1; 239/302

(57) ABSTRACT

Vegetation spray is performed with a magnetized material in a spray liquid. The magnetized material can be liquid iron. The magnetized material can be magnetized before or after introduction to the spray liquid, and before or after the spray liquid is introduced to spray equipment. Spray drift can be reduced and spray adhesion increased by the addition of the magnetized material to the spray liquid. Liquid with magnetized materials can also be used in other, non-spray applications.

### CROSS-REFERENCE TO RELATED APPLICATIONS

This application claims the benefit of U.S. Provisional Application Ser. No. 61/165,961, filed on Apr. 2, 2009, the content of which application is hereby incorporated by reference in its entirety.

### FIELD OF THE INVENTION

The present invention relates to the spraying of vegetation, and more particularly, to systems and methods for magnetizing spraying.

### BACKGROUND OF THE INVENTION

Vegetation spraying occurs for a variety of reasons. For example, herbicide solutions are sprayed onto weeds, or other plants considered undesirable at a given location, to eliminate them. Plants whose healthy growth is desired, such as agricultural crops, are sprayed with fungicides, pesticides, fertilizers and the like to treat potential problems and facilitate future growth.

Vegetation spraying is performed from a variety of different platforms. For instance, there are backpack sprayers carried by individuals, ground vehicle-mounted or towed sprayers and aerial sprayers. The liquid to be sprayed, usually an aqueous solution, is typically carried in a tank and expelled under pressure out of a nozzle.

Major concerns associated with vegetation spraying include spray drift and spray adhesion. Spray drift, typically caused by wind, refers to some portion of the sprayed liquid falling outside of the area to be sprayed (or “target area”). Spray drift is generally undesirable; various restrictions and regulations on spraying have been implemented in many areas to minimize the adverse effects of spray drift For example, a large buffer area may be required around the target area and certain restrictions may be placed on the type of spray equipment used (e.g., prohibitions on aerial spraying).

Spray adhesion refers to how well the sprayed liquid adheres to vegetation in the target area. High adhesion is generally preferable because less liquid needs to be sprayed to achieve a desired effect. Not only does this save water and chemicals, it also mitigates another large spray-related problem; runoff. Runoff, particularly agricultural runoff and the associated contamination of groundwater, is considered in many ways to be a larger environmental issue that spray drift.

The electrostatic charging of sprayed liquid, along the same principles used for electrostatic application of paint to metallic surfaces, has been used with mixed success to mitigate spray drift and improve adhesion. However, even where successful, the electrostatic approach requires large, extremely high voltage, expensive equipment, and has not been widely implemented.

Magnetization of a liquid to be sprayed has also been utilized to improve adhesion and other spray properties. An example of a nozzle, system and method for magnetizing a liquid for application to vegetation can be seen in U.S. Pat. No. 6,276,617, the contents of which are hereby incorporated by reference in their entirety. Magnetization of the liquid can lead to smaller droplet size, allowing better penetration into small areas, as well as improved attraction of the droplets to the foliage, allowing reduced liquid use.

To address iron chlorosis in vegetation, it is known to add chelated iron (also known as “liquid iron”) when watering. Iron is also present in trace amounts in fertilizers. However, the present inventor believes that it is not known to use liquid iron, or other magnetizable materials, in connection with current magnetic or electrostatic systems, or to address problems with spray drift and adhesion.

### SUMMARY OF THE INVENTION

Based on the foregoing, it is an object of the present invention to provide an improved system and method for vegetation spraying. According to an embodiment of the present invention, a vegetation spray system includes a storage tank, a liquid in the storage tank, a feed line, a spray nozzle and a pressure source for moving the liquid from the storage tank to the spray nozzle through the feed line. The system further includes a magnetizable material added to the liquid.

According to a method aspect of the present invention, a method for vegetation spray includes adding a magnetizable material to a liquid to be sprayed (a “spray liquid”), magnetizing the magnetizable material, and spraying the liquid with the magnetized material. According to a further aspect of the present invention, the magnetizing of the magnetizable material is performed before adding the magnetizable material to the liquid. The magnetizable material can be a non-trace concentration of liquid iron.

These and other objects, aspects and advantages of the present invention will be better appreciated in view of the drawings and following detailed description of a preferred embodiment.

### BRIEF DESCRIPTION OF THE DRAWINGS

FIG. 1 is a schematic plan view of an agricultural spray system, according to an embodiment of the present invention;

FIGS. 2 and 3 are schematic perspective views of alternate embodiments of a component of the system of FIG. 1; and

FIG. 4 is a magnetized liquid generation system, according to another embodiment of the present invention.

### DETAILED DESCRIPTION OF A PREFERRED EMBODIMENT

The present inventor has discovered that including a magnetized material, particularly liquid iron, in spray liquid results in a surprising reduction in spray drift and improved adhesion. The improvement in adhesion is somewhat counter-intuitive, as the inclusion of a magnetized material tends to increase droplet size. Additionally, the drift reduction appears not to be solely attributable to the larger droplet size. Also, some experimental evidence indicates that the inclusion of non-trace amounts of magnetized liquid iron in water may increase the water use efficiency of vegetation and enhance overall plant growth.

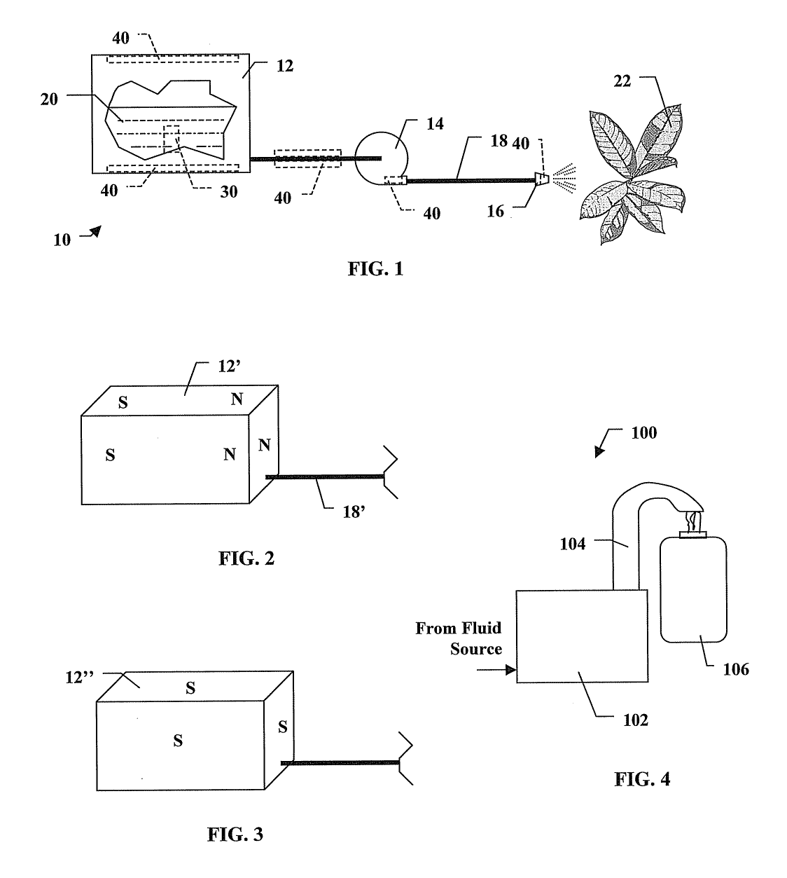

Referring to FIG. 1, according to an embodiment of the present invention, an vegetation spray system 10 includes a liquid storage tank 12, a pump 14 and a spray nozzle 16 connected by a feed line 18. Spray liquid 20 stored in the storage tank 12 is sucked into the line 18 by the pump 14 and discharged through the nozzle 16 onto foliage 22.

The spray liquid 20 is not necessarily limited to water, and could be any liquid sprayed on vegetation, although water or aqueous solutions are most common. A material having, or capable of retaining, a magnetic field in the absence of another magnetic field (herein called a “magnetizable material”), such as a ferromagnetic or ferrimagnetic material, is also added to the agricultural liquid. For example, an iron-containing solution, colloid or suspension can advantageously be added to the storage tank 12 (herein called “liquid iron”). A mixing system 30 can be employed within the tank 12 to ensure even dispersal of the magnetizable material throughout the agricultural liquid.

Although other magnetizable materials can be used, liquid iron is most preferred. Particularly, a chelated iron solution of at least approximately 0.5% by weight is preferred, and approximately 2% to approximately 5% by weight is more preferred. A concentration of approximately 2.5% by weight is believed to be close to optimal for many applications.

In operation, the liquid 20 and the magnetizable material are added to the storage tank 12. The pump 14 is then operated to spray the liquid 20 and magnetizable material through the feed line 18 and out the spray nozzle 16 onto the foliage 22. A magnetic field is imparted to the magnetizable material (i.e., the magnetizable material is “magnetized”) before exiting the spray nozzle 16.

Advantageously, the magnetizable material can be magnetized before or after introduction to the storage tank 12. If the magnetizable material is magnetized before introduction to the storage tank 12, then many benefits of magnetized spray can be realized without the need for any specialized spray equipment. Further, it has been determined that the magnetized particles of a liquid iron solution can continue to generate a detectable magnetic field for several weeks after being magnetized, even after the water has evaporated.

Alternately, the magnetizable material can be magnetized after introduction to the storage tank 12 by one or more magnets arranged 40 in the system. For example, the system 10 can include one or more magnets 40 associated with the tank 12, the pump 14, the spray nozzle 16 and/or the feed line 18. The magnets 40 can be attached to or integral with the associated components. For example, the nozzle 16 can include magnets inserted therein or one or more portions of the nozzle can be entirely formed from a magnetic material. In another example, the tank 12 could also be formed from a magnetic material with, for instance, an exterior and an interior coating for corrosion resistance.

Even if the magnetizable material is magnetized prior to introduction into the storage tank 12, the magnetization of the magnetizable material and the liquid can be enhanced by one or more magnets 40 of the system. Test results have shown a surprising and substantial gain in fluid attraction to plants when the magnetizable material is added to the agricultural liquid. In particular, adding liquid iron to distilled water in a spray system with a magnetic nozzle yielded an average 82% droplet weight gain per pot sprayed.

The above embodiment is provided for illustrative and exemplary purposes; the present invention is not necessarily limited thereto. Instead, those skilled in the art will appreciate that numerous modifications, as well as adaptations to particular circumstances, are possible within the scope of the present invention.

For example, there are many variations on spray systems equally utilizable in connections with aspects of the present invention. For example, spray systems using pressurized air as a pressure source in lieu of a pump could be employed. Additionally, induced flow systems, for instance using a venturi nozzle to vacuum drag a liquid stream into another stream to form a combined stream prior to exiting the spray nozzle, could also be employed. In such a system, the magnetizable material could be stored separately from the agricultural liquid and combined therewith during the spraying process.

Also, spray systems utilizing multiple spray nozzles, storage tanks and/or other components could be employed. Additionally, the spray systems could be stationary or mobile, for instance, truck or aircraft mounted spray systems.

Moreover, the present invention is not necessarily limited to a particular type of magnet, and can employ permanent magnets and/or electromagnets or other mechanisms for magnetizing the magnetizable material and/or agricultural liquid. The present invention can also include electrostatically charging the agricultural liquid and/or magnetizable material prior to spraying onto foliage.

Additionally, where magnets are employed, the present invention is not necessarily limited to a particular numbers, locations or configurations of magnets. For permanent magnets, it is preferable to employ the strongest permanent magnets having suitable material properties for a given application. In general, ceramic magnets offer superior properties. Also, magnetic polarities of separate magnets, if employed, are preferably selected to avoid demagnetization of a previously magnetized material.

For example, referring to FIGS. 2 and 3, two embodiments of a magnetized tank 12′, 12″ are shown. In the tank 12′, polarities of one or more magnets associated with the tank 12′ are aligned such that opposite ends of the tank experience fields with consistent and opposite polarities. For instance, an end of the tank 12′ proximate to the feed line 18′ experiences only a “north” polarity, while the distal end of the tank 12′ experiences only a “south” polarity.

In the tank 12″, polarities of one or more magnets associated with the tank 12″ are aligned such that the interior of the tank experiences one polarity and the exterior the opposite polarity. For instance, the interior the tank 12″ experiences the “north” polarity and the exterior experiences the “south” polarity.

Additionally, referring to FIG. 4, a magnetized liquid generation system 100 includes a magnetization tank 102, a tank outlet 104 and a fill container 106. The tank 102 receives a fluid, such as water, from a fluid source. A magnetizable material is mixed into the fluid in the tank 102, with a mixing or agitation mechanism or the like in the tank. If desired, a slurry can be formed in the tank 102. The tank outlet 104 allows the magnetized liquid from the tank 102 to be selectively dispensed in the fill container 106. The fill container 106 can be, for example, a tank for a spray or irrigation system, which then does not require separate means to magnetized the liquid therein. Magnets for magnetizing the liquid can be arranged in the water supply line, the tank, the outlet, or any combination thereof.

Additionally, referring to FIG. 4, a magnetized liquid generation system 100 includes a magnetization tank 102, a tank outlet 104 and a fill container 106. The tank 102 receives a fluid, such as water, from a fluid source. A magnetizable material is mixed into the fluid in the tank 102, with a mixing or agitation mechanism or the like in the tank. If desired, a slurry can be formed in the tank 102. The tank outlet 104 allows the magnetized liquid from the tank 102 to be selectively dispensed in the fill container 106. The fill container 106 can be, for example, a tank for a spray or irrigation system, which then does not require separate means to magnetized the liquid therein. Magnets for magnetizing the liquid can be arranged in the water supply line, the tank, the outlet, or any combination thereof.

Also, “vegetation” is used generically herein to refer to any plant life. Unless otherwise specified, the present invention is not necessarily limited to spray on any type of vegetation, or spraying vegetation for any particular purpose.

Additionally, the use of a liquid having a magnetized material therein can be used in other vegetation applications besides spraying. For example, magnetized materials can be used in connection with all types of irrigation; for instance, drip and seep irrigation, as well as controlled flooding.

The foregoing is not an exhaustive list of possible modifications and adaptations. Rather, those skilled in the art will appreciate that these and other variations fall within the scope of the invention herein shown and described and of the appended claims.

What is claimed is:

1. A method of spraying vegetation comprising:
adding a magnetizable material to a spray liquid;
magnetizing the magnetizable material; and
spraying the liquid onto the vegetation.

2. The method of claim 1, wherein the magnetizable material is liquid iron.

3. The method of claim 2, wherein the liquid iron is added to the spray liquid at a liquid iron concentration of at least approximately 0.5% by weight.

4. The method of claim 3, wherein the liquid iron concentration is approximately 2% to approximately 5% by weight.

5. The method of claim 4, wherein the liquid iron concentration is approximately 2.5% by weight.

6. The method of claim 1, wherein magnetizing the magnetizable material is performed before adding the magnetizable material to the spray liquid.

7. The method of claim 1, wherein magnetizing the magnetizable material performed after adding the magnetizable material to the spray liquid.

8. The method of claim 1, wherein magnetizing the magnetizable material performed during spraying.

9. The method of claim 1, wherein adding the magnetizable material to the spray liquid is performed prior to adding the spray liquid to spray equipment used for spraying the liquid.

10. The method of claim 1, wherein adding the magnetizable material to the spray liquid is performed after adding the spray liquid to spray equipment used for spraying the liquid.

11. The method of claim 1, wherein the adding the magnetizable material to the spray liquid is performed during spraying.

12. The method of claim 1, wherein the spray liquid is water.

13. The method of claim 1, wherein the spray liquid includes at least one of a fertilizer, a pesticide, an herbicide and a fungicide.

14. A method of reducing spray drift comprising:
adding chelated iron to a spray liquid;
magnetizing the chelated iron; and
spraying the spray liquid onto vegetation.

15. The method of claim 14, wherein a concentration of the chelated iron in the spray liquid is at least approximately 0.5% by weight.

16. The method of claim 15, wherein the concentration of the chelated iron in the spray liquid is approximately 2% to approximately 5% by weight.

17. The method of claim 14 wherein the vegetation being sprayed is not iron deficient.

18. The method of claim 14, wherein the chelated iron is magnetized prior to adding to spray equipment for spraying on the vegetation.

19. The method of claim 14, wherein the chelated iron is added to the spray liquid prior to introduction into spray equipment for spraying on the vegetation.

20. A vegetation spraying system comprising:
a spray liquid holding volume;
a spray outlet in fluid communication with the holding volume; and
a spray liquid including a magnetized material in the holding volume.
